(19) United States
(12) Patent Application Publication
(10) Pub. No.: US 2026/0011291 A1
(43) Pub. Date: Jan. 8, 2026

(54) GATE DRIVER AND ELECTRONIC APPARATUS INCLUDING THE SAME

(71) Applicant: Samsung Display Co., Ltd., Yongin-si (KR)

(72) Inventors: JUNHYUN PARK, Yongin-si (KR); YOUNGWAN SEO, Yongin-si (KR)

(21) Appl. No.: 19/087,325

(22) Filed: Mar. 21, 2025

(30) Foreign Application Priority Data
Jul. 4, 2024 (KR) 10-2024-0087950

(51) Int. Cl. G09G 3/32

(52) U.S. Cl. CPC G09G 3/32; G09G 2300/0819; G09G 2300/0842; G09G 2310/0267; G09G 2310/0286; G09G 2310/06

(57) ABSTRACT

A gate driver including stages, the stages including a control circuit and first to M^{th} output circuits outputting first to M^{th} output signals, the first to M^{th} output circuits including a pull-up transistor configured to transmit a high gate voltage to an output terminal, a buffer transistor configured to transmit a corresponding clock signal among first to M^{th} clock signals to the output terminal, an always-on transistor connected between the control node and a gate of the buffer transistor, and a boost capacitor connected between the output terminal and the gate of the buffer transistor. A capacitance of the boost capacitor of the first output circuit may be different from at least one of capacitances of the boost capacitors of the second to M^{th} output circuits.

### CROSS-REFERENCE TO RELATED APPLICATION

This application claims priority to, and the benefit of, Korean Patent Application No. 10-2024-0087950 filed on Jul. 4, 2024, in the Korean Intellectual Property Office (KIPO), the entire disclosure of which is incorporated by reference herein.

### BACKGROUND

### 1. Field

Embodiments relate to a display device including a gate driver with improved reliability, and an electronic apparatus including the display device.

### 2. Description of the Related Art

A display device may include a display panel, a data driver, and a gate driver. The display panel may include a plurality of pixels. The data driver may provide data signals to the pixels. The gate driver may provide gate signals to the pixels.

The gate driver may include a plurality of stages. Each of the stages may include a control circuit and a plurality of output circuits that share a control node of the control circuit. The output circuits may sequentially output gate signals. When a delay deviation occurs between the gate signals in periods in which the gate signals are sequentially output, reliability of the gate driver may be degraded.

### SUMMARY

Embodiments provide a gate driver with improved reliability and an electronic apparatus including the gate driver.

According to one or more embodiments, an electronic apparatus includes a processor configured to generate image data, and a display device configured to display an image based on the image data, the display device including a display panel including pixels, and a gate driver including stages configured to provide gate signals to the pixels, the stages including a control circuit configured to control a signal of a control node, and a signal of an inverting control node, based on an input signal, and first to Mth output circuits, M being a natural number greater than or equal to 3, configured to respectively output first to Mth output signals based on the signal of the control node and the signal of the inverting control node, and including a pull-up transistor configured to transmit a high gate voltage to an output terminal in response to the signal of the inverting control node, a buffer transistor configured to transmit a corresponding clock signal among first to Mth clock signals to the output terminal in response to the signal of the control node, an always-on transistor connected between the control node and a gate of the buffer transistor, and configured to be maintained in a turned-on state, and a boost capacitor connected between the output terminal and the gate of the buffer transistor, and wherein a capacitance of the boost capacitor of the first output circuit is different from at least one of capacitances of the boost capacitors of the second to Mth output circuits.

The capacitances of the boost capacitors of the first to Mth output circuits may be different from each other.

The first to Mth output circuits may be configured to sequentially output pulses of the first to Mth clock signals as the first to Mth output signals.

The control circuit may include a first transistor configured to transmit the input signal to the control node in response to an M+1th clock signal, a second transistor including a gate connected to the inverting control node, a first terminal configured to receive the high gate voltage, and a second terminal, and a third transistor including a gate configured to receive one of the first to Mth clock signals, a first terminal connected to the second terminal of the second transistor, and a second terminal connected to the control node.

The control circuit may further include a fourth transistor configured to transmit the M+1th clock signal to the inverting control node in response to the signal of the control node.

The control circuit may further include a fifth transistor configured to transmit

a low gate voltage to the inverting control node in response to the M+1th clock signal.

The control circuit may further include a first capacitor including a first terminal configured to receive the high gate voltage and a second terminal connected to the inverting control node.

According to one or more embodiments, a gate driver includes stages, the

stages including a control circuit configured to control a signal of a control node and a signal of an inverting control node based on an input signal, and first to Mth output circuits, M being a natural number greater than or equal to 3, configured to respectively output first to Mth output signals based on the signal of the control node and the signal of the inverting control node, and including a pull-up transistor configured to transmit a high gate voltage to an output terminal in response to the signal of the inverting control node, a buffer transistor configured to transmit a corresponding clock signal among first to Mth clock signals to the output terminal in response to the signal of the control node, an always-on transistor connected between the control node and a gate of the buffer transistor, and configured to be maintained in a turned-on state, and a boost capacitor connected between the output terminal and the gate of the buffer transistor, wherein a length of a channel of the buffer transistor of the first output circuit is different from at least one of lengths of channels of the buffer transistors of the second to Mth output circuits.

The lengths of the channels of the buffer transistors of the first to Mth output circuits may be different from each other.

The first to Mth output circuits may be configured to sequentially output pulses of the first to Mth clock signals as the first to Mth output signals.

The control circuit may include a first transistor configured to transmit the input signal to the control node in response to an M+1th clock signal, a second transistor including a gate connected to the inverting control node, a first terminal configured to receive the high gate voltage, and a second terminal, and a third transistor including a gate configured to receive one of the first to Mth clock signals, a first terminal connected to the second terminal of the second transistor, and a second terminal connected to the control node.

The control circuit may further include a fourth transistor configured to transmit the M+1th clock signal to the inverting control node in response to the signal of the control node.

The control circuit may further include a fifth transistor configured to transmit a low gate voltage to the inverting control node in response to the M+1th clock signal.

The control circuit may further include a first capacitor including a first terminal configured to receive the high gate voltage, and a second terminal connected to the inverting control node.

According to one or more embodiments, a gate driver includes stages, the stages including a control circuit configured to control a signal of a control node and a signal of an inverting control node based on an input signal, and first to Mth output circuits, M being a natural number greater than or equal to 3, configured to respectively output first to Mth output signals based on the signal of the control node and the signal of the inverting control node, and including a pull-up transistor configured to transmit a high gate voltage to an output terminal in response to the signal of the inverting control node, a buffer transistor configured to transmit a corresponding clock signal among first to Mth clock signals to the output terminal in response to the signal of the control node, an always-on transistor connected between the control node and a gate of the buffer transistor, and configured to be maintained in a turned-on state, a boost capacitor connected between the output terminal and the gate of the buffer transistor, and a parasitic capacitor connected to the gate of the buffer transistor, and wherein a capacitance of the parasitic capacitor of the first output circuit is different from at least one of capacitances of the parasitic capacitors of the second to Mth output circuits.

The capacitances of the parasitic capacitors of the first to Mth output circuits may be different from each other.

The first to Mth output circuits may be configured to sequentially output pulses of the first to Mth clock signals as the first to Mth output signals.

The control circuit may include a first transistor configured to transmit the input signal to the control node in response to an M+1th clock signal, a second transistor including a gate connected to the inverting control node, a first terminal configured to receive the high gate voltage, and a second terminal, and a third transistor including a gate configured to receive one of the first to Mth clock signals, a first terminal connected to the second terminal of the second transistor, and a second terminal connected to the control node.

The control circuit may further include a fourth transistor configured to transmit the M+1th clock signal to the inverting control node in response to the signal of the control node.

The control circuit may further include a fifth transistor configured to transmit a low gate voltage to the inverting control node in response to the M+1th clock signal. In the gate driver according to embodiments, a voltage level deviation

between boosted signals of the gates of the seventh transistors (buffer transistors) of the first to Mth output circuits of the stage may decrease, so that a delay deviation between the first to Mth output signals may decrease. Accordingly, the reliability of the gate driver may be improved.

### BRIEF DESCRIPTION OF THE DRAWINGS

Illustrative, non-limiting embodiments will be more clearly understood from the following detailed description taken in conjunction with the accompanying drawings.

FIG. 1 is a block diagram showing a display device according to one or more embodiments.

FIG. 2 is a circuit diagram showing a pixel of FIG. 1.

FIG. 3 is a block diagram showing a first gate driver of FIG. 1.

FIG. 4 is a circuit diagram showing a stage of a gate driver according to one or more embodiments.

FIG. 5 is a timing diagram showing signals of the stage of FIG. 4.

FIG. 6 is a circuit diagram showing a stage of a gate driver according to one or more embodiments.

FIG. 7 is a circuit diagram showing a stage of a gate driver according to one or more embodiments.

FIG. 8 is a block diagram showing an electronic apparatus according to one or more embodiments.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

The terms “overlap” or “overlapped” mean that a first object may be above or below or to a side of a second object, and vice versa. Additionally, the term “overlap” may include stack, face or facing, extending over, covering, or partly covering or any other suitable term as would be appreciated and understood by those of ordinary skill in the art. The terms “face” and “facing” may mean that a first object may directly or indirectly oppose a second object. In a case in which a third object intervenes between a first and second object, the first and second objects may be understood as being indirectly opposed to one another, although still facing each other.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection.

For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XY, YZ, and XZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.” Furthermore, the expression “being the same” may mean “being substantially the same”. In other words, the expression “being the same” may include a range that can be tolerated by those of ordinary skill in the art. The other expressions may also be expressions from which “substantially” has been omitted.

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Hereinafter, a gate driver and an electronic apparatus according to embodiments of the present disclosure will be described in more detail with reference to the accompanying drawings. The same or similar reference numerals will be used for the same elements in the accompanying drawings.

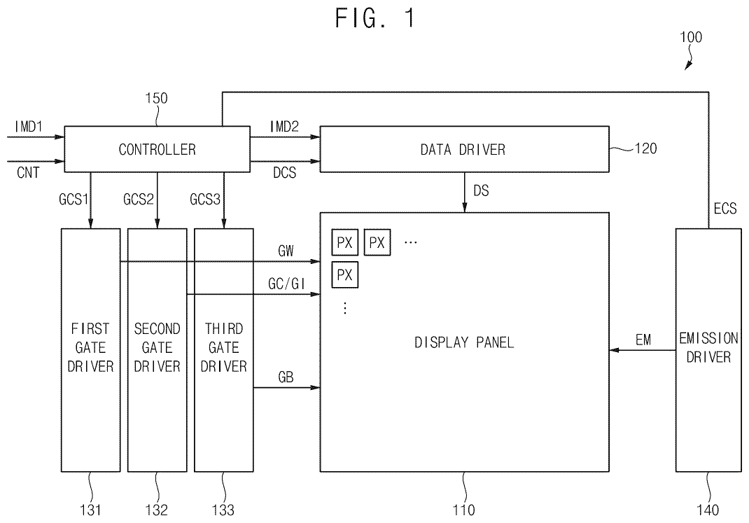

FIG. 1 is a block diagram showing a display device 100 according to one or more embodiments.

Referring to FIG. 1, the display device 100 may include a display panel 110, a data driver 120, a first gate driver 131, a second gate driver 132, a third gate driver 133, an emission driver 140, and a controller 150.

The display panel 110 may include a plurality of pixels PX. Each of the pixels PX may receive a data signal DS, a write gate signal GW, a compensation gate signal GC, an initialization gate signal GI, a bypass gate signal GB, and an emission signal EM. The display panel 110 may display an image including color dots displayed by the pixels PX, respectively.

The data driver 120 may provide data signals DS to the pixels PX. The data driver 120 may generate the data signals DS based on second image data IMD2 and a data control signal DCS. The second image data IMD2 may include grayscale values corresponding to the pixels PX. The data control signal DCS may include a load signal, a data clock signal, etc.

The first gate driver 131 may provide write gate signals GW to the pixels PX. The first gate driver 131 may generate the write gate signals GW based on a first gate control signal GCS1. The first gate control signal GCS1 may include a first gate start signal, a first gate clock signal, etc.

The second gate driver 132 may provide compensation gate signals GC and initialization gate signals GI to the pixels PX. The second gate driver 132 may generate the compensation gate signals GC and the initialization gate signals GI based on a second gate control signal GCS2. The second gate control signal GCS2 may include a second gate start signal, a second gate clock signal, etc.

The third gate driver 133 may provide bypass gate signals GB to the pixels PX. The third gate driver 133 may generate the bypass gate signals GB based on a third gate control signal GCS3. The third gate control signal GCS3 may include a third gate start signal, a third gate clock signal, etc.

The emission driver 140 may provide emission signals EM to the pixels PX. The emission driver 140 may generate the emission signals EM based on an emission control signal ECS. The emission control signal ECS may include an emission start signal, an emission clock signal, etc.

The controller 150 may control an operation of the data driver 120, an operation of the first gate driver 131, an operation of the second gate driver 132, an operation of the third gate driver 133, and an operation of the emission driver 140. The controller 150 may provide the second image data IMD2 and the data control signal DCS to the data driver 120, may provide the first gate control signal GCS1 to the first gate driver 131, may provide the second gate control signal GCS2 to the second gate driver 132, may provide the third gate control signal GCS3 to the third gate driver 133, and may provide the emission control signal ECS to the emission driver 140. The controller 150 may generate the second image data IMD2 based on first image data IMD1, and may generate the data control signal DCS, the first gate control signal GCS1, the second gate control signal GCS2, the third gate control signal GCS3, and the emission control signal ECS based on a controller control signal CNT. The first image data IMD1 may include grayscale values corresponding to pixels PX. The controller control signal CNT may include a master clock signal, a data enable signal, a vertical synchronization signal, a horizontal synchronization signal, etc.

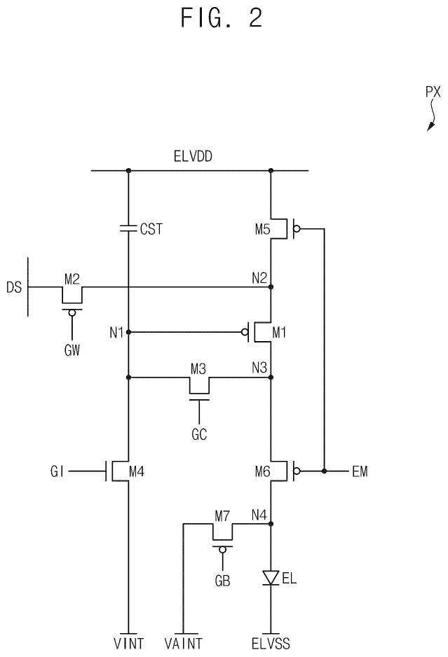

FIG. 2 is a circuit diagram showing the pixel PX of FIG. 1.

Referring to FIGS. 1 and 2, the pixel PX may include a driving transistor M1, a writing transistor M2, a compensation transistor M3, an initialization transistor M4, a first emission transistor M5, a second emission transistor M6, a bypass transistor M7, a storage capacitor CST, and a light-emitting element EL.

The driving transistor M1 may generate a driving current corresponding to a voltage difference between a first node N1 and a second node N2. The driving transistor M1 may include a gate connected to the first node N1, a first terminal connected to the second node N2, and a second terminal connected to a third node N3.

The writing transistor M2 may transmit the data signal DS to the second node N2 in response to the write gate signal GW. The write transistor M2 may include a gate that receives the write gate signal GW, a first terminal that receives the data signal DS, and a second terminal connected to the second node N2.

The compensation transistor M3 may connect the third node N3 to the first node N1 in response to the compensation gate signal GC. The compensation transistor M3 may include a gate that receives the compensation gate signal GC, a first terminal connected to the third node N3, and a second terminal connected to the first node N1.

The initialization transistor M4 may transmit a first initialization voltage VINT to the first node N1 in response to the initialization gate signal GI. The initialization transistor M4 may include a gate that receives the initialization gate signal GI, a first terminal that receives the first initialization voltage VINT, and a second terminal connected to the first node N1.

The first emission transistor M5 may transmit a first power voltage ELVDD to the second node N2 in response to the emission signal EM. The first emission transistor M5 may include a gate that receives the emission signal EM, a first terminal that receives the first power voltage ELVDD, and a second terminal connected to the second node N2.

The second emission transistor M6 may connect the third node N3 to a fourth node N4 in response to the emission signal EM. The second emission transistor M6 may include a gate that receives the emission signal EM, a first terminal connected to the third node N3, and a second terminal connected to the fourth node N4.

The bypass transistor M7 may transmit a second initialization voltage VAINT to the fourth node N4 in response to the bypass gate signal GB. The bypass transistor M7 may include a gate that receives the bypass gate signal GB, a first terminal that receives the second initialization voltage VAINT, and a second terminal connected to the fourth node N4.

The storage capacitor CST may store a signal of the first node N1. The storage capacitor CST may include a first terminal connected to the first node N1, and a second terminal that receives the first power voltage ELVDD.

The light-emitting element EL may emit light with a luminance corresponding to the driving current. The light-emitting element EL may include a first terminal connected to the fourth node N4, and a second terminal that receives a second power voltage ELVSS.

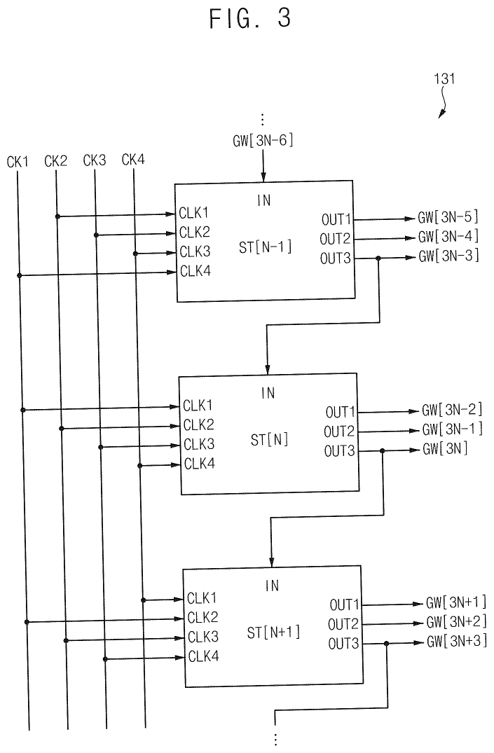

FIG. 3 is a block diagram showing the first gate driver 131 of FIG. 1.

Referring to FIGS. 1 and 3, the first gate driver 131 may include a plurality of stages . . . , ST[N−1], ST[N], ST[N+1], . . . (N is a natural number greater than or equal to 2). The first gate driver 131 may receive the first gate start signal and first to fourth clocks CK1, CK2, CK3, and CK4, and may output a plurality of write gate signals . . . , GW[3N−5], GW[3N−4], GW[3N−3], GW[3N−2], GW[3N−1], GW[3N], GW[3N+1], GW[3N+2], GW[3N+3], . . . . In this case, the first gate clock signal may include the first to fourth clocks CK1, CK2, CK3, and CK4. Hereinafter, the first gate driver 131 is referred to as a gate driver.

Each of the stages . . . , ST[N−1], ST[N], ST[N+1], . . . may receive an input signal IN and first to fourth clock signals CLK1, CLK2, CLK3, and CLK4, and may output first to third output signals OUT1, OUT2, and OUT3. Although FIG. 3 illustrates that each of the stages . . . , ST[N−1], ST[N], ST[N+1], . . . receives four clock signals CLK1, CLK2, CLK3, and CLK4 and outputs three output signals OUT1, OUT2, and OUT3, the present disclosure is not limited thereto, and each of the stages . . . , ST[N−1], ST[N], ST[N+1], . . . may receive M+1 (M is a natural number greater than or equal to 3) clock signals, and may output M output signals.

An N−1^{th} stage ST[N−1] may receive a 3N=6^{th} write gate signal GW[3N−6] as the input signal IN, the second clock CK2 as the first clock signal CLK1, the third clock CK3 as the second clock signal CLK2, the fourth clock CK4 as the third clock signal CLK3, and the first clock CK1 as the fourth clock signal CLK4, and may output a 3N−5^{th} write gate signal GW[3N−5] as the first output signal OUT1, a 3N−4^{th} write gate signal GW[3N−4] as the second output signal OUT2, and a 3N−3^{th} write gate signal GW[3N−3] as the third output signal OUT3.

An N^{th} stage ST[N] may receive the 3N−3^{th} write gate signal GW[3N−3] as the input signal IN, the first clock CK1 as the first clock signal CLK1, the second clock CK2 as the second clock signal CLK2, the third clock CK3 as the third clock signal CLK3, and the fourth clock CK4 as the fourth clock signal CLK4, and may output a 3N−2^{th} write gate signal GW[3N−2] as the first output signal OUT1, a 3N−1^{th} write gate signal GW[3N−1] as the second output signal OUT2, and a 3N^{th} write gate signal GW[3N] as the third output signal OUT3.

An N+1^{th} stage ST[N+1] may receive the 3N^{th} write gate signal GW[3N] as the input signal IN, the fourth clock CK4 as the first clock signal CLK1, the first clock CK1 as the second clock signal CLK2, the second clock CK2 as the third clock signal CLK3, and the third clock CK3 as the fourth clock signal CLK4, and may output a 3N+1^{th} write gate signal GW[3N+1] as the first output signal OUT1, a 3N+2^{th} write gate signal GW[3N+2] as the second output signal OUT2, and a 3N+3^{th} write gate signal GW[3N+3] as the third output signal OUT3.

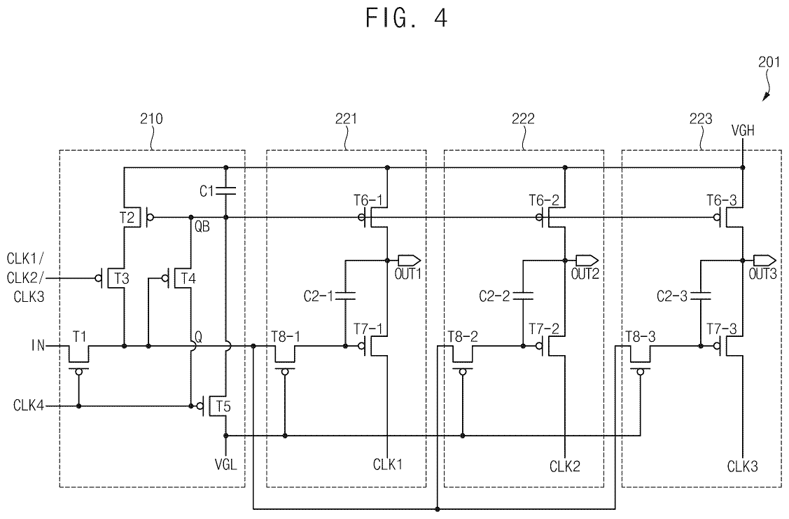

FIG. 4 is a circuit diagram showing a stage 201 of a gate driver according to one or more embodiments.

Referring to FIG. 4, the stage 201 may include a control circuit 210 and first to third output circuits 221, 222, and 223. The first to third output circuits 221, 222, and 223 may output the first to third output signals OUT1, OUT2, and OUT3, respectively. Although FIG. 4 illustrates that the stage 201 includes three output circuits 221, 222, and 223 that output three output signals OUT1, OUT2, and OUT3, the present disclosure is not limited thereto, and the stage 201 may include M output circuits that output M output signals, respectively.

The control circuit 210 may control a signal of a control node Q and a signal of an inverting control node QB based on the input signal IN. The control circuit 210 may include a first transistor T1, a second transistor T2, a third transistor T3, a fourth transistor T4, a fifth transistor T5, and a first capacitor C1.

The first transistor T1 may transmit the input signal IN to the control node Q in response to the fourth clock signal CLK4. The first transistor T1 may include a gate that receives the fourth clock signal CLK4, a first terminal (e.g., a source) that receives the input signal IN, and a second terminal (e.g., a drain) connected to the control node Q.

The second transistor T2 may include a gate connected to the inverting control node QB, a first terminal (e.g., a source) that receives a high gate voltage VGH, and a second terminal (e.g., a drain).

The third transistor T3 may include a gate that receives one of the first to third clock signals CLK1, CLK2, or CLK3, a first terminal (e.g., a source) connected to the second terminal of the second transistor T2, and a second terminal (e.g., a drain) connected to the control node Q.

The fourth transistor T4 may transmit the fourth clock signal CLK4 to the inverting control node QB in response to the signal of the control node Q. The fourth transistor T4 may include a gate connected to the control node Q, a first terminal (e.g., a source) that receives the fourth clock signal CLK4, and a second terminal (e.g., a drain) connected to the inverting control node QB.

The fifth transistor T5 may transmit a low gate voltage VGL to the inverting control node QB in response to the fourth clock signal CLK4. The fifth transistor T5 may include a gate that receives the fourth clock signal CLK4, a first terminal (e.g., a source) receiving the low gate voltage VGL, and a second terminal (e.g., a drain) connected to the inverting control node QB.

The first capacitor C1 may store the signal of the inverting control node QB. The first capacitor C1 may include a first terminal that receives the high gate voltage VGH and a second terminal connected to the inverting control node QB.

The first to third output circuits 221, 222, and 223 may output the first to third output signals OUT1, OUT2, and OUT3, respectively, based on the signal of the control node Q and the signal of the inverting control node QB. The first output circuit 221 may include a sixth-first transistor T6-1, a seventh-first transistor T7-1, an eighth-first transistor T8-1, and a second-first capacitor C2-1. The second output circuit 222 may include a sixth-second transistor T6-2, a seventh-second transistor T7-2, an eighth-second transistor T8-2, and a second-second capacitor C2-2. The third output circuit 223 may include a sixth-third transistor T6-3, a seventh-third transistor T7-3, an eighth-third transistor T8-3, and a second-third capacitor C2-3. Hereinafter, for convenience of description, the sixth-first transistor T6-1, the sixth-second transistor T6-2, and the sixth-third transistor T6-3 are referred to as a sixth transistor T6, the seventh-first transistor T7-1, the seventh-second transistor T7-2, and the seventh-third transistor T7-3 are referred to as a seventh transistor T7, the eighth-first transistor T8-1, the eighth-second transistor T8-2, and the eighth-third transistor T8-3 are referred to as an eighth transistor T8, and the second-first capacitor C2-1, the second-second capacitor C2-2, and the second-third capacitor C2-3 are referred to as a second capacitor C2.

The sixth transistor T6 may transmit the high gate voltage VGH to an output terminal in response to the signal of the inverting control node QB. The sixth transistor T6 may include a gate connected to the inverting control node QB, a first terminal (e.g., a source) that receives the high gate voltage VGH, and a second terminal (e.g., a drain) connected to the output terminal. The sixth transistor T6 may be referred to as a pull-up transistor.

The seventh transistor T7 may transmit a corresponding clock signal among the first to third clock signals CLK1, CLK2, and CLK3 to the output terminal in response to the signal of the control node Q. The seventh transistor T7 may include a gate connected to the control node Q via the eighth transistor T8, a first terminal (e.g., a source) that receives the corresponding clock signal among the first to third clock signals CLK1, CLK2, and CLK3, and a second terminal (e.g., a drain) connected to the output terminal. The seventh transistor T7 may be referred to as a buffer transistor.

The seventh-first transistor T7-1 may transmit the first clock signal CLK1 to an output terminal from which the first output signal OUT1 is output in response to the signal of the control node Q. The seventh-second transistor T7-2 may transmit the second clock signal CLK2 to an output terminal from which the second output signal OUT2 is output in response to the signal of the control node Q. The seventh-third transistor T7-3 may transmit the third clock signal CLK3 to an output terminal from which the third output signal OUT3 is output in response to the signal of the control node Q.

The eighth transistor T8 may be connected between the control node Q and the gate of the seventh transistor T7, and may be, generally, always maintained in a turned-on state. The eighth transistor T8 may include a gate that receives the low gate voltage VGL, a first terminal (e.g., a source) connected to the control node Q, and a second terminal (e.g., a drain) connected to the gate of the seventh transistor T7. The eighth transistor T8 may be referred to as an always-on transistor (AOT).

The second capacitor C2 may be connected between the output terminal and the gate of the seventh transistor T7. The second capacitor C2 may boost a signal of the gate of the seventh transistor T7 in response to a change in the output signal OUT1, OUT2, or OUT3 output from the output terminal. The second capacitor C2 may include a first terminal connected to the output terminal, and a second terminal connected to the gate of the seventh transistor T7. The second capacitor C2 may be referred to as a boost capacitor.

A capacitance of the second-first capacitor C2-1 may be different from at least one of a capacitance of the second-second capacitor C2-2 or a capacitance of the second-third capacitor C2-3. In one or more embodiments, the capacitance of the second-first capacitor C2-1, the capacitance of the second-second capacitor C2-2, and the capacitance of the second-third capacitor C2-3 may be different from each other.

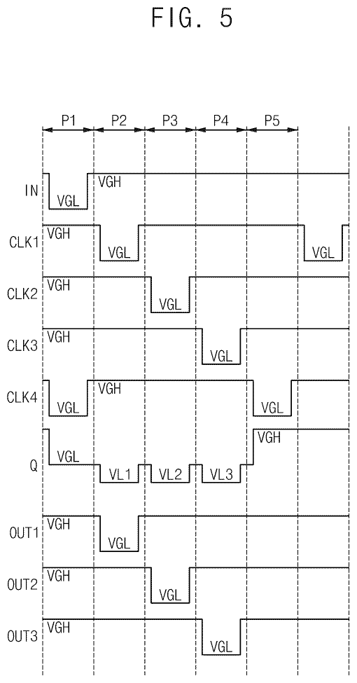

FIG. 5 is a timing diagram showing signals of the stage 201 of FIG. 4.

Referring to FIGS. 4 and 5, each of a pulse of the input signal IN, a pulse of the first clock signal CLK1, a pulse of the second clock signal CLK2, a pulse of the third clock signal CLK3, and a pulse of the fourth clock signal CLK4 may have the low gate voltage VGL.

In a first period P1, the first transistor T1 may be turned on in response to the pulse of the fourth clock signal CLK4 so that the pulse of the input signal IN may be transmitted to the control node Q, and so that the seventh-first transistor T7-1, the seventh-second transistor T7-2, and the seventh-third transistor T7-3 may be turned on. In the first period P1, each of the first to third clock signals CLK1, CLK2, and CLK3 may have the high gate voltage VGH, and accordingly, the first output circuit 221 may output the first output signal OUT1 having the high gate voltage VGH, the second output circuit 222 may output the second output signal OUT2 having the high gate voltage VGH, and the third output circuit 223 may output the third output signal OUT3 having the high gate voltage VGH.

In a second period P2, the first clock signal CLK1 may change from the high gate voltage VGH to the low gate voltage VGL, and accordingly, the first output circuit 221 may output the first output signal OUT1 having the low gate voltage VGL. In the second period P2, the first output signal OUT1 may change from the high gate voltage VGH to the low gate voltage VGL, and a signal of the gate of the seventh-first transistor T7-1 may be boosted by a voltage corresponding to a difference between the low gate voltage VGL and the high gate voltage VGH due to a coupling effect of the second-first capacitor C2-1. In this case, the signal of the control node Q may change to a first low voltage VL1 obtained by subtracting a threshold voltage of the eighth-first transistor T8-1 from the low gate voltage VGL.

In a third period P3, the second clock signal CLK2 may change from the high gate voltage VGH to the low gate voltage VGL, and accordingly, the second output circuit 222 may output the second output signal OUT2 having the low gate voltage VGL. In the third period P3, the second output signal OUT2 may change from the high gate voltage VGH to the low gate voltage VGL, and a signal of the gate of the seventh-second transistor T7-2 may be boosted by a voltage corresponding to a difference between the low gate voltage VGL and the high gate voltage VGH due to a coupling effect of the second-second capacitor C2-2. In this case, the signal of the control node Q may change to a second low voltage VL2 obtained by subtracting a threshold voltage of the eighth-second transistor T8-2 from the low gate voltage VGL.

In a fourth period P4, the third clock signal CLK3 may change from the high gate voltage VGH to the low gate voltage VGL, and accordingly, the third output circuit 223 may output the third output signal OUT3 having the low gate voltage VGL. In the fourth period P4, the third output signal OUT3 may change from the high gate voltage VGH to the low gate voltage VGL, and a signal of the gate of the seventh-third transistor T7-3 may be boosted by a voltage corresponding to a difference between the low gate voltage VGL and the high gate voltage VGH due to a coupling effect of the second-third capacitor C2-3. In this case, the signal of the control node Q may change to a third low voltage VL3 obtained by subtracting a threshold voltage of the eighth-third transistor T8-3 from the low gate voltage VGL.

If a deviation between the threshold voltage of the eighth-first transistor T8-1, the threshold voltage of the eighth-second transistor T8-2, and the threshold voltage of the eighth-third transistor T8-3 increases, a voltage level deviation between the first to third low voltages VL1, VL2, and VL3, which are signals of the control node Q in the second to fourth periods P2, P3, and P4, may increase, and accordingly, a voltage level deviation between the boosted signal of the gate of the seventh-first transistor T7-1, the boosted signal of the gate of the seventh-second transistor T7-2, and the boosted signal of the gate of the seventh-third transistor T7-3 may increase. Accordingly, a delay deviation between the first to third output signals OUT1, OUT2, and OUT3 may increase, and reliability of the gate driver may be degraded.

However, the capacitance of the second-first capacitor C2-1, the capacitance of the second-second capacitor C2-2, and the capacitance of the second-third capacitor C2-3 may be different from each other, and accordingly, even if the deviation between the threshold voltage of the eighth-first transistor T8-1, the threshold voltage of the eighth-second transistor T8-2, and the threshold voltage of the eighth-third transistor T8-3 increases, the voltage level deviation between the boosted signal of the gate of the seventh-first transistor T7-1, the boosted signal of the gate of the seventh-second transistor T7-2, and the boosted signal of the gate of the seventh-third transistor T7-3 may decrease. Accordingly, the delay deviation between the first to third output signals OUT1, OUT2, and OUT3 may decrease, and the reliability of the gate driver may be improved.

In the second to fourth periods P2, P3, and P4, the first to third output circuits 221, 222, and 223 may sequentially output the pulses of the first to third clock signals CLK1, CLK2, and CLK3 as the first to third output signals OUT1, OUT2, and OUT3.

In a fifth period P5, the first transistor T1 may be turned on in response to the pulse of the fourth clock signal CLK4 so that the input signal IN having the high gate voltage VGH may be transmitted to the control node Q, and the seventh-first transistor T7-1, the seventh-second transistor T7-2, and the seventh-third transistor T7-3 may be turned off. In the fifth period P5, the fifth transistor T5 may be turned on in response to the pulse of the fourth clock signal CLK4 so that the low gate voltage VGL may be transmitted to the inverting control node QB, and the sixth-first transistor T6-1, the sixth-second transistor T6-2, and the sixth-third transistor T6-3 may be turned on. Accordingly, the first output circuit 221 may output the first output signal OUT1 having the high gate voltage VGH, the second output circuit 222 may output the second output signal OUT2 having the high gate voltage VGH, and the third output circuit 223 may output the third output signal OUT3 having the high gate voltage VGH.

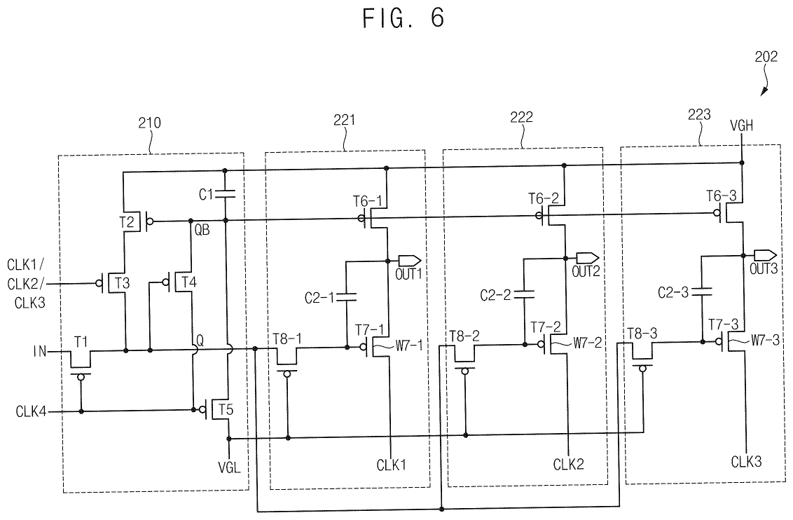

FIG. 6 is a circuit diagram showing a stage 202 of a gate driver according to one or more embodiments.

Referring to FIG. 6, the stage 202 may include a control circuit 210 and first to third output circuits 221, 222, and 223. Descriptions of components of the stage 202 described with reference to FIG. 6, which are substantially the same as or similar to those of the stage 201 described with reference to FIG. 4, are omitted.

The seventh transistor T7 may include a gate connected to the control node Q through the eighth transistor T8, a first terminal (e.g., a source) that receives a corresponding clock signal among the first to third clock signals CLK1, CLK2, and CLK3, a second terminal (e.g., a drain) connected to the output terminal, and a channel defined between the first terminal and the second terminal. In one or more embodiments, the channel of the seventh transistor T7 may overlap the gate of the seventh transistor T7, and may be insulated from the gate of the seventh transistor T7.

A length of the channel W7-1 of the seventh-first transistor T7-1 may be different from at least one of a length of the channel W7-2 of the seventh-second transistor T7-2 or a length of the channel W7-3 of the seventh-third transistor T7-3. In one or more embodiments, the length of the channel W7-1 of the seventh-first transistor T7-1, the length of the channel W7-2 of the seventh-second transistor T7-2, and the length of the channel W7-3 of the seventh-third transistor T7-3 may be different from each other.

The length of the channel W7-1 of the seventh-first transistor T7-1, the length of the channel W7-2 of the seventh-second transistor T7-2, and the length of the channel W7-3 of the seventh-third transistor T7-3 may be different from each other, and accordingly, even if the deviation between the threshold voltage of the eighth-first transistor T8-1, the threshold voltage of the eighth-second transistor T8-2, and the threshold voltage of the eighth-third transistor T8-3 increases, the voltage level deviation between the boosted signal of the gate of the seventh-first transistor T7-1, the boosted signal of the gate of the seventh-second transistor T7-2, and the boosted signal of the gate of the seventh-third transistor T7-3 may decrease. Accordingly, the delay deviation between the first to third output signals OUT1, OUT2, and OUT3 may decrease, and the reliability of the gate driver may be improved.

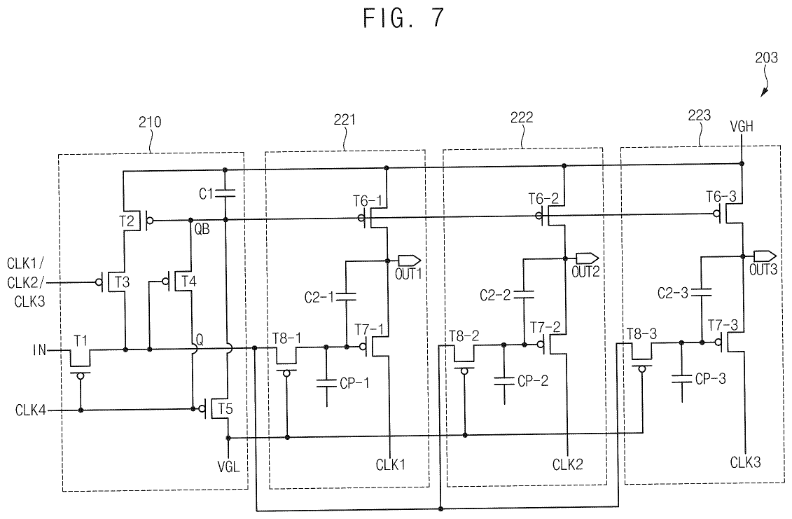

FIG. 7 is a circuit diagram showing a stage 203 of a gate driver according to one or more embodiments.

Referring to FIG. 7, the stage 203 may include a control circuit 210 and first to third output circuits 221, 222, and 223. Descriptions of components of the stage 203 described with reference to FIG. 7, which are substantially the same as or similar to those of the stage 201 described with reference to FIG. 4, are omitted.

The first output circuit 221 may further include a first parasitic capacitor CP-1 connected to the gate of the seventh-first transistor T7-1. The second output circuit 222 may further include a second parasitic capacitor CP-2 connected to the gate of the seventh-second transistor T7-2. The third output circuit 223 may further include a third parasitic capacitor CP-3 connected to the gate of the seventh-third transistor T7-3.

A capacitance of the first parasitic capacitor CP-1 may be different from at least one of a capacitance of the second parasitic capacitor CP-2 or a capacitance of the third parasitic capacitor CP-3. In one or more embodiments, the capacitance of the first parasitic capacitor CP-1, the capacitance of the second parasitic capacitor CP-2, and the capacitance of the third parasitic capacitor CP-3 may be different from each other.

The capacitance of the first parasitic capacitor CP-1, the capacitance of the second parasitic capacitor CP-2, and the capacitance of the third parasitic capacitor CP-3 may be different from each other, and accordingly, even if the deviation between the threshold voltage of the eighth-first transistor T8-1, the threshold voltage of the eighth-second transistor T8-2, and the threshold voltage of the eighth-third transistor T8-3 increases, the voltage level deviation between the boosted signal of the gate of the seventh-first transistor T7-1, the boosted signal of the gate of the seventh-second transistor T7-2, and the boosted signal of the gate of the seventh-third transistor T7-3 may decrease. Accordingly, the delay deviation between the first to third output signals OUT1, OUT2, and OUT3 may decrease, and the reliability of the gate driver may be improved.

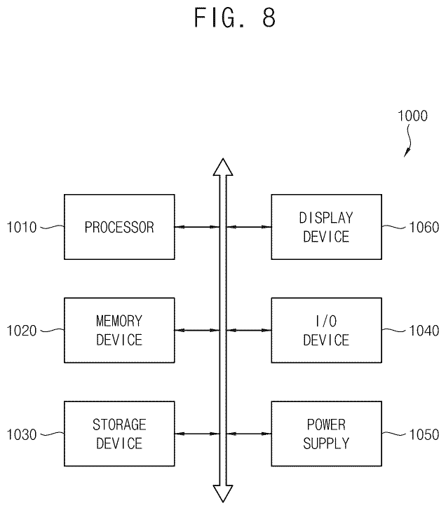

FIG. 8 is a block diagram showing an electronic apparatus 1000 according to one or more embodiments.

Referring to FIG. 8, the electronic apparatus 1000 may include a processor 1010, a memory device 1020, a storage device 1030, an input/output (I/O) device 1040, a power supply 1050, and a display device 1060. The electronic apparatus 1000 may further include a plurality of ports capable of communicating with a video card, a sound card, a memory card, a USB device, and the like, or communicating with other systems.

The processor 1010 may perform corresponding calculations or tasks. In one or more embodiments, the processor 1010 may be a microprocessor, a central processing unit (CPU), or the like. The processor 1010 may be connected to other components through an address bus, a control bus, a data bus, and the like. In one or more embodiments, the processor 1010 may also be connected to an expansion bus, such as a peripheral component interconnect (PCI) bus. In one or more embodiments, the processor 1010 may generate the first image data IMD1 of FIG. 1 and the controller control signal CNT of FIG. 1, and may provide the first image data IMD1 and the controller control signal CNT to the display device 1060.

The memory device 1020 may store data required for an operation of the electronic apparatus 1000. For example, the memory device 1020 may include: a nonvolatile memory device, such as an erasable programmable read-only memory (EPROM), an electrically erasable programmable read-only memory (EEPROM), a flash memory, a phase change random access memory (PRAM), a resistance random access memory (RRAM), a nano floating gate memory (NFGM), a polymer random access memory (PoRAM), a magnetic random access memory (MRAM), or a ferroelectric random access memory (FRAM); and/or a volatile memory device, such as a dynamic random access memory (DRAM), a static random access memory (SRAM), or a mobile DRAM.

The storage device 1030 may include a solid state drive (SSD), a hard disk drive (HDD), a CD-ROM, and the like. The I/O device 1040 may include: an input device, such as a keyboard, a keypad, a touch pad, a touch screen, or a mouse; and an output device, such as a speaker or a printer. The power supply 1050 may supply a power required for the operation of the electronic apparatus 1000. The display device 1060 may be connected to other components through the buses or other communication links. The display device 1060 may correspond to the display device 100 of FIG. 1. The display device 1060 may display an image based on the first image data IMD1.

The gate driver according to the embodiments may be applied to a display device included in a computer, a notebook, a mobile phone, a smart phone, a smart pad, a smart watch, a PMP, a PDA, an MP3 player, or the like.

Although the gate driver and the electronic apparatus according to the embodiments have been described with reference to the drawings, the illustrated embodiments are examples, and may be modified and changed by a person having ordinary knowledge in the relevant technical field without departing from the technical spirit described in the following claims, with functional equivalents thereof to be included therein.

What is claimed is:

1. An electronic apparatus comprising a processor configured to generate image data, and a display device configured to display an image based on the image data, the display device comprising:
a display panel comprising pixels; and
a gate driver comprising stages configured to provide gate signals to the pixels, the stages comprising:
a control circuit configured to control a signal of a control node, and a signal of an inverting control node, based on an input signal; and
first to M^{th} output circuits, M being a natural number greater than or equal to 3, configured to respectively output first to M^{th} output signals based on the signal of the control node and the signal of the inverting control node, and comprising:
a pull-up transistor configured to transmit a high gate voltage to an output terminal in response to the signal of the inverting control node;
a buffer transistor configured to transmit a corresponding clock signal among first to M^{th} clock signals to the output terminal in response to the signal of the control node;
an always-on transistor connected between the control node and a gate of the buffer transistor, and configured to be maintained in a turned-on state; and
a boost capacitor connected between the output terminal and the gate of the buffer transistor, and
wherein a capacitance of the boost capacitor of the first output circuit is different from at least one of capacitances of the boost capacitors of the second to M^{th} output circuits.

2. The electronic apparatus of claim 1, wherein the capacitances of the boost capacitors of the first to M^{th} output circuits are different from each other.

3. The electronic apparatus of claim 1, wherein the first to M^{th} output circuits are configured to sequentially output pulses of the first to M^{th} clock signals as the first to M^{th} output signals.

4. The electronic apparatus of claim 1, wherein the control circuit comprises:
a first transistor configured to transmit the input signal to the control node in response to an M+1^{th} clock signal;
a second transistor comprising a gate connected to the inverting control node, a first terminal configured to receive the high gate voltage, and a second terminal; and
a third transistor comprising a gate configured to receive one of the first to M^{th} clock signals, a first terminal connected to the second terminal of the second transistor, and a second terminal connected to the control node.

5. The electronic apparatus of claim 4, wherein the control circuit further comprises a fourth transistor configured to transmit the M+1^{th} clock signal to the inverting control node in response to the signal of the control node.

6. The electronic apparatus of claim 4, wherein the control circuit further comprises a fifth transistor configured to transmit a low gate voltage to the inverting control node in response to the M+1^{th} clock signal.

7. The electronic apparatus of claim 4, wherein the control circuit further comprises a first capacitor comprising a first terminal configured to receive the high gate voltage and a second terminal connected to the inverting control node.

8. A gate driver comprising stages, the stages comprising:
a control circuit configured to control a signal of a control node and a signal of an inverting control node based on an input signal; and
first to M^{th} output circuits, M being a natural number greater than or equal to 3, configured to respectively output first to M^{th} output signals based on the signal of the control node and the signal of the inverting control node, and comprising:
a pull-up transistor configured to transmit a high gate voltage to an output terminal in response to the signal of the inverting control node;
a buffer transistor configured to transmit a corresponding clock signal among first to M^{th} clock signals to the output terminal in response to the signal of the control node;
an always-on transistor connected between the control node and a gate of the buffer transistor, and configured to be maintained in a turned-on state; and
a boost capacitor connected between the output terminal and the gate of the buffer transistor,
wherein a length of a channel of the buffer transistor of the first output circuit is different from at least one of lengths of channels of the buffer transistors of the second to M^{th} output circuits.

9. The gate driver of claim 8, wherein the lengths of the channels of the buffer transistors of the first to M^{th} output circuits are different from each other.

10. The gate driver of claim 8, wherein the first to M^{th} output circuits are configured to sequentially output pulses of the first to M^{th} clock signals as the first to M^{th} output signals.

11. The gate driver of claim 8, wherein the control circuit comprises:
a first transistor configured to transmit the input signal to the control node in response to an M+1^{th} clock signal;
a second transistor comprising a gate connected to the inverting control node, a first terminal configured to receive the high gate voltage, and a second terminal; and
a third transistor comprising a gate configured to receive one of the first to M^{th} clock signals, a first terminal connected to the second terminal of the second transistor, and a second terminal connected to the control node.

12. The gate driver of claim 11, wherein the control circuit further comprises a fourth transistor configured to transmit the M+1^{th} clock signal to the inverting control node in response to the signal of the control node.

13. The gate driver of claim 11, wherein the control circuit further comprises a fifth transistor configured to transmit a low gate voltage to the inverting control node in response to the M+1^{th} clock signal.

14. The gate driver of claim 11, wherein the control circuit further comprises a first capacitor comprising a first terminal configured to receive the high gate voltage, and a second terminal connected to the inverting control node.

15. A gate driver comprising stages, the stages comprising:
a control circuit configured to control a signal of a control node and a signal of an inverting control node based on an input signal; and
first to M^{th} output circuits, M being a natural number greater than or equal to 3, configured to respectively output first to M^{th} output signals based on the signal of the control node and the signal of the inverting control node, and comprising:
a pull-up transistor configured to transmit a high gate voltage to an output terminal in response to the signal of the inverting control node;
a buffer transistor configured to transmit a corresponding clock signal among first to M^{th} clock signals to the output terminal in response to the signal of the control node;
an always-on transistor connected between the control node and a gate of the buffer transistor, and configured to be maintained in a turned-on state;
a boost capacitor connected between the output terminal and the gate of the buffer transistor; and
a parasitic capacitor connected to the gate of the buffer transistor, and
wherein a capacitance of the parasitic capacitor of the first output circuit is different from at least one of capacitances of the parasitic capacitors of the second to M^{th} output circuits.

16. The gate driver of claim 15, wherein the capacitances of the parasitic capacitors of the first to M^{th} output circuits are different from each other.

17. The gate driver of claim 15, wherein the first to M^{th} output circuits are configured to sequentially output pulses of the first to M^{th} clock signals as the first to M^{th} output signals.

18. The gate driver of claim 15, wherein the control circuit comprises:
a first transistor configured to transmit the input signal to the control node in response to an M+1^{th} clock signal;
a second transistor comprising a gate connected to the inverting control node, a first terminal configured to receive the high gate voltage, and a second terminal; and
a third transistor comprising a gate configured to receive one of the first to M^{th} clock signals, a first terminal connected to the second terminal of the second transistor, and a second terminal connected to the control node.

19. The gate driver of claim 18, wherein the control circuit further comprises a fourth transistor configured to transmit the M+1^{th} clock signal to the inverting control node in response to the signal of the control node.

20. The gate driver of claim 18, wherein the control circuit further includes a fifth transistor configured to transmit a low gate voltage to the inverting control node in response to the M+1^{th} clock signal.
